(19) United States
(12) Patent Application Publication
(10) Pub. No.: US 2006/0110522 A1
(43) Pub. Date: May 25, 2006

(54) Edible fat/oil composition

(75) Inventors: Shinji Seki, Kanagawa (JP); Ichirou Hidaka, Kanagawa (JP); Shin Arimoto, Kanagawa (JP); Hisako Yoshino, Kanagawa (JP); Junichi Ikuina, Kanagawa (JP)

Correspondence Address: BACON & THOMAS, PLLC, 625 SLATERS LANE, FOURTH FLOOR, ALEXANDRIA, VA, 22314, US

(73) Assignee: The Nisshin OilliO Group, Ltd., Tokyo (JP)

(21) Appl. No.: 11/320,636

(22) Filed: Dec. 30, 2005

Related U.S. Application Data
(62) Division of application No. 10/620,337, filed on Jul. 17, 2003.
Application No. 10/620,337 is a continuation of application No. PCT/JP02/00336, filed on Jan. 18, 2002.

(30) Foreign Application Priority Data
Jan. 19, 2001 (JP) 2001-012331

(51) Int. Cl. A23D 9/00

(52) U.S. Cl. 426/601

(57) ABSTRACT

An edible fat/oil composition containing a plant sterol, which permits suppressing the deposition of the plant sterol during, for example, the storage and which produces the effect of, for example, inhibiting the absorption of cholesterol, contains an edible fat/oil, linolenic acid in an amount of 1 mass % or more, a plant sterol in an amount of 1 mass % to 10 mass %, tocopherol in an amount of 0.01 mass % to 1 mass %, and a lipophilic emulsifying agent in an amount of 0.005 mass % to 10 mass %.

### CROSS-REFERENCE TO RELATED APPLICATIONS

This is a Continuation Application of PCT Application No. PCT/JP02/00336, filed Jan. 18, 2002, which was not published under PCT Article 21(2) in English.

This application is based upon and claims the benefit of priority from the prior Japanese Patent Application No. 2001-012331, filed Jan. 19, 2001, the entire contents of which are incorporated herein by reference.

### BACKGROUND OF THE INVENTION

1. Field of the Invention

The present invention relates to an edible fat/oil composition, particularly, to an edible fat/oil composition containing a plant cholesterol.

2. Description of the Related Art

Diet therapy is performed for controlling cholesterol in the human body as a measure against life-style related diseases. As diet therapy, the intake of food containing a large amount of cholesterol is limited. In addition, components inhibiting the absorption of cholesterol are taken in simultaneously. Since cholesterol is contained in a large amount in, for example, meat, fish and eggs, it is expected to allow the edible oil used for cooking these foodstuffs to contain a plant sterol that is known to inhibit the absorption of cholesterol. However, in order to obtain the above-noted effect produced by the plant sterol, it is necessary to allow the edible oil to contain the plant sterol in a high concentration. In this case, a problem is generated that the plant sterol deposits during the storage. Conversely, where the plant sterol is contained in a low concentration, it is impossible to obtain the function of inhibiting the absorption of cholesterol. Particularly, the problem is that it is difficult to obtain a product such as a so-called “salad oil” that also satisfies the cooking capability simultaneously.

However, the plant sterol tends to be crystallized so as to deposit from the edible oil if stored for a long time under the state that the plant sterol is contained in the edible fat/oil or is stored under low temperatures. Particularly, the tendency is rendered prominent if the amount of plant sterol in the edible fat/oil is increased. As a result, the function of the plant sterol to inhibit the absorption of cholesterol is markedly lowered.

Accordingly, a main object of the present invention is to provide an edible fat/oil containing plant sterol, which permits suppressing the deposition of the plant sterol during, for example, the storage of the edible fat/oil and which also permits producing the effect of inhibiting the absorption of cholesterol. Another object of the present invention is to provide an edible fat/oil composition containing the plant sterol, which is excellent in cooking adaptability.

### BRIEF SUMMARY OF THE INVENTION

As a result of an extensive research conducted in an attempt to achieve the objects described above, the present inventors have found that, if an edible fat/oil contains a lipophilic emulsifying agent together with specified components, it is possible to suppress the deposition of the plant sterol even in the case where the edible fat/oil contains a relatively large amount of plant sterol, making it possible to manufacture a commercial product or to use the edible fat/oil such as, for example, general salad oil, and that the absorption of cholesterol can be inhibited by the synergetic effect produced by the plant sterol and the specified components even if the intake of the plant sterol is smaller than that in the general case, thereby arriving at the completion of the present invention.

To be more specific, according to the present invention, there is provided an edible fat/oil composition, comprising an edible fat/oil, and containing linolenic acid in an amount of 1 mass % or more, a plant sterol in an amount of 1 mass % to 10 mass %, tocopherol in an amount of 0.01 mass % to 1 mass %, and a lipophilic emulsifying agent in an amount of 0.005 mass % to 10 mass %.

In the present invention, the edible fat/oil preferably contains a plant fat/oil. In this case, it is more preferable that the edible fat/oil contain 10 mass % or more of rice oil. In the latter case, the edible fat/oil composition of the present invention may contain oryzanol in an amount of 0.01 mass % to 2 mass %.

In the present invention, usually, a plant sterol is added, in addition to the plant sterol contained in the edible fat/oil itself. In this case, it is preferable that the plant sterol added have been subjected to a deodorizing treatment.

The lipophilic emulsifying agent used in the present invention may be one or more of emulsifying agents selected from the group consisting of sucrose fatty acid ester, glycerin fatty acid ester, sorbitan fatty acid ester, and propylene glycol fatty acid ester. Particularly, in the case of using at least one lipophilic emulsifying agent (first emulsifying agent) selected from the group consisting of sucrose fatty acid ester, glycerin fatty acid ester, sorbitan fatty acid ester, and propylene glycol fatty acid ester, each having an HLB value of 6 or less, it is possible to suppress more effectively the deposition of the plant sterol from the edible fat/oil.

Also, in the case of using at least one second lipophilic emulsifying agent selected from the group consisting of sucrose fatty acid ester and glycerin fatty acid ester, each having an HLB value of 7 or less, it is possible to suppress effectively the bubbling in the cooking step under heat.

The edible fat/oil composition of the present invention may be prepared such that saturated fatty acids among the fatty acid residues of the components contained in the composition is contained in the composition in an amount of 15 mass % or less.

The edible fat/oil composition of the present invention produces the effect of inhibiting the absorption of cholesterol.

Also, the edible fat/oil composition of the present invention is particularly desirable when used for cooking.

Further, according to the present invention, there is provided a food/drink using the edible fat/oil composition of the present invention.

Also, according to the present invention, there is provided a processed fat/oil product containing the edible fat/oil composition of the present invention.

Also, according to the present invention, there is provided a cooking method under heat, in which the edible fat/oil composition of the present invention is used for the cooking under heat.

Still further, according to the present invention, there is provided a method of preparing a food/drink, in which the edible fat/oil composition of the present invention is used as a raw material.

### DETAILED DESCRIPTION OF THE INVENTION

The present invention will now be described in more detail.

The edible fat/oil composition of the present invention contains linolenic acid in an amount of 1 mass % or more, a plant sterol in an amount of 1 mass % to 10 mass %, tocopherol in an mount of 0.01 mass % to 1 mass %, and a lipophilic emulsifying agent in an amount of 0.005 mass % to 10 mass %. These components are mixed with an edible fat/oil.

The edible fat/oil used in the present invention includes a plant fat/oil, an animal fat/oil, diglyceride and refined and processed edible fat/oil. As these fats/oils, it is possible to use processed oils and refined oils such as extracted oils, crude oils, deoxidized oils, degummed oils, and dewaxed oils as well as discolored oils before the deodorizing process. The plant fats/oils used in the present invention include, for example, soybean oil, soybean germ oil, rapeseed oil, cone oil, sesame oil, sesame salad oil, a beefsteak plant oil, linseed oil, peanut oil, a higher oleic acid safflower oil, sunflower oil, a higher oleic acid sunflower oil, cotton seed oil, grape seed oil, macademianut oil, hazelnut oil, pumpkin seed oil, walnut oil, camellia oil, tea seed oil, perilla oil, bollarge oil, olive oil, rice bran oil, wheat germ oil, palm oil, palm nucleus oil, coconut oil, cacao oil, alga oils, and classified oils thereof, though the plant fats/oils used in the present invention are not limited to those exemplified above. On the other hand, the animal fats/oils used in the present invention include, for example, tallow, lard, hen oil, milk fat, fish fat, seal oil, and classified oils thereof, though the animal fats/oils used in the present invention are not limited to those exemplified above. Diglyceride is a diester between glycerin and a fatty acid derived from animal and plant oils. It is possible to use a diglyceride prepared by hydrolysis of a fat/oil, followed by refining the hydrolyzate, or a diglyceride prepared by esterification between glycerin and a fatty acid, followed by refining the resultant ester, though the diglyceride used in the present invention is not limited to those exemplified above. The refined and processed edible fats/oils used in the present invention include, for example, synthetic fats/oils such as a middle chain fatty acid triglyceride (MCT) and triacetin and an ester exchange oil (MLCT), though the refined and processed edible fats/oils used in the present invention are not limited to those exemplified above. It is desirable for the edible fat/oil used in the present invention to be in the form of a liquid at room temperature (about 25° C.) and, more desirably, to have a transparency. It is desirable to use the plant fat/oil exemplified above as the edible fat/oil meeting the particular requirements.

The linolenic acid contained in the edible fat/oil composition of the present invention is contained in general in the form of a glyceride in the edible fats/oils exemplified above, particularly, in the plant fats/oils such as rapeseed oil. At least 1 mass % of the linolenic acid is the amount of the linolenic acid in the form of glyceride, which is converted into the free linolenic acid.

Where the edible fat/oil composition of the present invention contains oryzanol in an amount of 0.01 to 2 mass %, it is possible to use, as the edible fat/oil, rice oil or a mixed edible fat/oil containing rice oil because rice oil contains about 0.1 to 2 mass % of oryzanol. In this case, it is desirable for the edible fat/oil to contain at least 10 mass % of rice oil.

Tocopherol contained in the edible fat/oil composition of the present invention is equal to that which is generally contained in the edible fat/oil and, thus, it is unnecessary in some cases to mix tocopherol in the edible fat/oil composition of the present invention.

The plant sterol used in the present invention includes the plant sterol obtained by condensing and refining the deodorized distillate obtained in the deodorizing process of plant fats/oils such as soybean oil, soybean germ oil, rapeseed oil, cone oil, sesame oil, sesame salad oil, a beefsteak plant oil, linseed oil, peanut oil, a higher oleic acid safflower oil, sunflower oil, a higher oleic acid sunflower oil, cotton seed oil, grape seed oil, macademianut oil, hazelnut oil, pumpkin seed oil, walnut oil, camellia oil, tea seed oil, perilla oil, bollarge oil, olive oil, rice bran oil, wheat germ oil, palm oil, palm nucleus oil, coconut oil, cacao oil, and alga oils. These plant sterol components include, for example, brasica sterols, campesterols, stigmasterols, sitosterols, isofucosterol, delta 5-avenasterols, and 7-ergosterols. The plant sterol used in the present invention also includes components having a similar chemical structure such as sitostanols, campestanols, and stigmastanols. However, the components are not limited in the plant sterol used in the present invention.

The plant sterol used in the present invention is obtained by condensing and refining the deodorized distillate by the combination of a solvent separation, hydrolysis, distillation and an adsorption treatment, though the plant sterol used in the present invention is not limited to those exemplified above. In other words, the plant sterol used in the present invention includes the plant sterol having a low refined degree. The solvents used for the solvent separation include, for example, hexane, acetone, methanol, ethanol, isopropyl alcohol (IPA) and acetic acid, thought the solvents used in the present invention are not limited to those exemplified above.

The edible fat/oil composition of the present invention contains the plant sterol in an amount of 1 to 10 mass %. The plant sterol content noted above represents the sum of the plant sterol originally contained in the edible fat/oil (generally, 0.5 to 1.5 mass % of plant sterol being contained in the plant fat/oil) and the plant sterol that can be separately mixed with the composition. Also, the plant sterol is present partly in the form of a fatty acid ester, and the plant sterol content noted above represents the value converted into the plant sterol in the free form.

It is desirable for the plant sterol, which is mixed in the composition of the present invention, to be used after the deodorizing treatment. However, the plant sterol has a melting point of 120° C. or more. Therefore, if the plant sterol is subjected as it is to the ordinary degreasing and deodorizing treatment of the fat/oil, the scattered particles are attached to the vacuum line of the degreasing and deodorizing apparatus and, then, solidified, clogging the vacuum line. It follows that it is possible to bring about the problem that the deodorizing treatment cannot be carried out. The present inventors have found that it is possible to overcome the particular problem by adding a plant sterol to the edible fat/oil so as to deodorize the mixture. In this case, it is desirable for the addition amount of the plant sterol to the edible fat/oil to be small. To be more specific, it is desirable for the addition amount of the plant sterol to fall within a range of 0.1 to 10 mass %, more desirably, 0.1 to 5 mass %, based on the total amount of the mixture.

As a result of an extensive research on the deodorizing treatment applied to the raw material mixture containing the particular plant sterol described above and the edible fat/oil, the present inventors have found that the volatile organic compounds having a molecular weight of 110 or less, which are used as the organic solvent in the extracting process of the edible fat/oil and in the refining process of the deodorized distillate, such as acetone, methyl ethyl ketone (MEK), methanol, ethanol, IPA, butyl alcohol, isobutyl alcohol, acetic acid, butyric acid, isobutyric acid, dimethyl formamide (DMF), dimethyl sulfoxide (DMSO), ether, tetrahydro furan (THF), pentane, hexane, heptane, benzene, toluene and xylene adversely affect the flavor of the edible fat/oil composition of the present invention, and that it is possible to improve the flavor by removing these volatile organic compounds sufficiently. It is also necessary for the plant sterol itself not to be removed significantly in carrying out the deodorizing treatment.

To be more specific, the deodorizing treatment is applied in the present invention to a mixture containing the plant sterol and the edible fat/oil under the temperature of 100° C. to 270° C., which is high enough to remove sufficiently the volatile organic compounds having a molecular weight of 110 or less and low enough to prevent the plant sterol from being removed significantly. It is desirable for the deodorizing temperature to fall within a range of 150° C. to 265° C., and more desirably, 180° C. to 260° C.

In the present invention, it is desirable for the deodorizing treatment to be carried out by a reduced pressure steam distillation, which is employed for the deodorizing treatment of the ordinary edible fat/oil. In order to remove the volatile organic compounds adversely affecting the flavor of the edible fat/oil, it is necessary to carry out the reduced pressure steam distillation under conditions of reasonable levels in terms of the temperature and the degree of the pressure reduction. It should be noted, however, that the plant sterol itself is also removed if the conditions are excessively severe. To be more specific, the deodorizing treatment by the reduced pressure steam distillation should be carried out at 100 to 270° C., desirably at 150 to 265° C., and more desirably, at 180 to 260° C. as described above under a reduced pressure of 1 to 30 Torr. It is desirable to control the deodorizing time within a range of 30 minutes to 600 minutes in view of the temperature and the reduced pressure conditions. To be more specific, it is desirable for the deodorizing time to be long under the low temperature and to be short under the high temperature. Also, the amount of the steam used is not particularly limited. It suffices to use the steam in an amount equal to that used in the deodorizing treatment applied to the ordinary edible fat/oil, i.e., 0.01 to 30% by weight in general based on the amount of the edible fat/oil composition containing the plant sterol.

In the present invention, it is desirable to deodorize the raw material mixture containing the plant sterol and the edible fat/oil such that the amounts of the volatile organic compounds having a molecular weight of 110 or less are lowered to a level lower than 5 mass ppm, i.e., 5/1,000,000 of the mass of the plant sterol. By the particular deodorizing treatment, it is possible to obtain an edible fat/oil composition containing the plant sterol and excellent in flavor.

The particular deodorizing treatment permits improving the flavor of the edible fat/oil composition of the present invention. The expression “improved flavor” noted above includes both the improvement in the flavor of the fat/oil composition itself and the improvement in the flavor of the cooked food prepared by the cooking using the fat/oil composition of the present invention, e.g., the flavor of the fried food.

Incidentally, the plant sterol is also removed to some extent in the deodorizing process. It is possible to recover the removed plant sterol and to add again the recovered plant sterol to the edible fat/oil as the whole or a part of the plant sterol contained in a mixture of the edible fat/oil and the plant sterol. If the mixture thus prepared is subjected to a deodorizing treatment, it is possible to fully utilize effectively the plant sterol, which is advantageous in economy.

It is possible to add an emulsifying agent described below to the deodorized mixture consisting of the plant sterol and the edible fat/oil as described above. Alternatively, it is possible to add the emulsifying agent described below to the mixture before the deodorizing treatment consisting of the plant sterol and the edible fat/oil, followed by subjecting the mixture to a deodorizing treatment.

As already described, the edible fat/oil composition of the present invention contains 0.005 to 10 mass % of a lipophilic emulsifying agent. Where the lipophilic emulsifying agent is contained in the edible fat/oil composition of the present invention in the amount described above, the deposition of the plant sterol from the composition can be significantly suppressed. The preferred lipophilic emulsifying agents used in the present invention include, for example, sucrose fatty acid ester, glycerin fatty acid ester, sorbitan fatty acid ester, and propylene glycol fatty acid ester.

In the lipophilic emulsifying agent used in the present invention, a polyglycerin fatty acid ester, particularly, polyglycerin condensed ricinoleate, is included in the glycerin fatty acid ester. Sorbitan mono-oleate is included in the sorbitan fatty acid ester. Further, propylene glycol mono-oleate is included in the propylene glycol fatty acid ester.

The plant sterol tends to deposit easily with increase in the water content. However, the present inventors have found that the lipophilic emulsifying agents having an HLB value of 6 or less, e.g., sucrose fatty acid ester, glycerin fatty acid ester, sorbitan fatty acid ester and/or propylene glycol fatty acid ester, permit suppressing the deposition of the plant sterol within the edible fat/oil composition even under a relatively high water content and also permit improving the resistance of the plant sterol-containing edible fat/oil composition to the refrigeration. Incidentally, the resistance to the refrigeration referred to above implies that, when the edible fat/oil composition is stored under an environment of low temperatures (1 to 5° C.) as in, for example, a refrigerator, the clouding and deposition caused by, for example, the wax component and the triglyceride having a high melting point are not generated, not to mention the deposition of the plant sterol. It is desirable for the emulsifying agent having an HLB value of 6 or less to be contained in an amount of 0.005 to 5 mass % based on the edible fat/oil composition of the present invention.

The present inventors have also found that, in order to improve the cooking capability by suppressing the foaming in the cooking step under heat, it is desirable for the edible fat/oil composition of the present invention to contain as the lipophilic emulsifying agent 0.0001 to 5 mass %, more desirably, 0.1 to 2 mass %, based on 1 mass % of the plant sterol, of at least one emulsifying agent (second emulsifying agent) having an HLB value of 7 or less, which is selected from the group consisting of polyglycerin sugar fatty acid ester and sucrose fatty acid ester. It is desirable for these emulsifying agent capable of suppressing the foaming to be contained in the edible fat/oil composition of the present invention in an amount of 0.005 to 5 mass %. Incidentally, the emulsifying agent capable of suppressing the foaming and used for improving the cooking capability overlaps with the emulsifying agent for suppressing the deposition of the plant sterol, which has an HLB value of 6 or less, in the polyglycerin sugar fatty acid ester and the sucrose fatty acid ester each having an HLB value of 6 or less. In the case of using the polyglycerin sugar fatty acid ester and/or the sucrose fatty acid ester having an HLB value of 6 or less both as the emulsifying agent for suppressing the deposition of the plant sterol and as the emulsifying agent for suppressing the foaming, it suffices to determine the amount of polyglycerin sugar fatty acid ester and/or sucrose fatty acid ester by adding the amount required for preventing the deposition of the plant sterol or the amount required for improving the resistance to refrigeration to the amount required for suppressing the foaming. At any rate, the edible fat/oil composition of the present invention contains 0.005 to 10 mass % in total of the lipophilic emulsifying agent.

It is desirable to prepare the edible fat/oil composition of the present invention such that the fatty acids (including those in the form of esters) included in the components constituting the edible fat/oil composition of the present invention are allowed to contain a saturated fatty acid in an amount of 15 mass % or less.

It is possible for the edible fat/oil composition of the present invention, which contains the plant sterol, to further contain ordinary components such as salts, thickening polysaccharides, organic acids, perfumes, sugars, polysaccharides, alcohols, antioxidants and medical components in addition to the components described above.

The edible fat/oil composition of the present invention contains a plant sterol and, thus, produces the effect of inhibiting the absorption of cholesterol. The composition also contains tocopherol and linolenic acid and, thus, the effect of inhibiting the absorption of cholesterol can be further improved. As a result, the edible fat/oil composition of the present invention, which contains the plant sterol, produces the effect of inhibiting the absorption of cholesterol, if the composition is taken in continuously even in the case of taking in the composition in a relatively small amount. If oryzanol is contained in the edible fat/oil composition of the present invention, which contains the plant sterol, the effect of inhibiting the absorption of cholesterol can be further improved. Also, the edible fat/oil composition of the present invention, which contains the plant sterol, also contains desirably a lipophilic emulsifying agent having an HLB value of 6 or less. Therefore, the composition of the present invention permits suppressing the deposition of the plant sterol so as to make it possible to store the edible fat/oil composition of the present invention with a high stability when the composition is stored under low temperatures or is stored for a long time. The edible fat/oil composition of the present invention, which contains the plant sterol, also contains an emulsifying agent having an HLB value of 7 or less. As a result, the foaming is suppressed in the cooking step under heat so as to further improve the adaptability to the cooking under heat. To be more specific, according to the present invention, it is possible to manufacture a commercial product that can be handled like, for example, the ordinary salad oil because the edible fat/oil composition of the present invention is capable of holding the transparency for a long time and is adapted for the cooking in spite of the construction that the composition contains the plant sterol. Also, in this case, the composition of the present invention can be used as the ordinary fat/oil for the cooking. As a result, it is possible to take in the plant sterol continuously for a long time so as to make it possible to obtain suitably the effect of inhibiting the absorption of cholesterol even in the case where the concentration of the plant sterol in the edible fat/oil composition of the present invention is relatively low. Further, linolenic acid, tocopherol and oryzanol contained in the edible fat/oil composition of the present invention collectively produce a synergetic effect so as to make it possible to obtain a more suitable effect of inhibiting the absorption of cholesterol.

The edible fat/oil composition of the present invention, which contains the plant sterol, can be used as a fat/oil composition for cooking, i.e., can be used as, for example, a frying oil, a frizzling oil, or a releasing oil. For cooking under heat, the edible fat/oil composition of the present invention can be used like ordinary fat/oil so as to cook various fried articles and frizzled articles. The flavor of the food cooked by using the edible fat/oil composition of the present invention is satisfactory, compared with the flavor of the food cooked by using, for example, ordinary salad oil. Further, the edible fat/oil composition of the present invention, which contains the plant sterol, can be used for manufacturing fat/oil processed foods such as dressing, a coffee whitener, a whip cream, mayonnaise, an emulsified dressing, margarine, fat spread, shortening, and ice cream, for manufacturing an edible emulsified fat/oil such as a fermented milk food, and for manufacturing foods such as bread and a cake.

The present invention will now be described with reference to Examples. Of course, the technical scope of the present invention is not limited by the following Examples.

The edible fat/oil compositions shown in the following table (Examples 1 to 9) were prepared so as to look into the transparency, the cooking adaptability, the flavor, and the effect of suppressing (inhibiting) the absorption of cholesterol. The results are also shown in the following table.

| | | Example 2 | Example 3 | Example 4 | Example 5 |
|---|---|---|---|---|---|
| | Example 1 | Soybean oil + | Soybean oil + | Soybean oil + | Sunflower oil + |
| | Soybean oil | Plant sterol | Plant sterol | Plant sterol | Plant sterol |
| Plant sterol | 0.8 | 2.1 | 2.1 | 2.1 | 2.1 |
| content | | | | | |
| Lipophilic | | | | | |
| emulsifying | | | | | |
| agent | | | | | |
| 1. For | No addition | 0 | Polyglycerin | Polyglycerin | Polyglycerin |
| suppressing | | | condensed | condensed | condensed |
| deposition | | | ricinoleate | ricinoleate | ricinoleate |
| (mass %) | | | ester (0.001) | ester (0.05) | ester (0.05) |
| 2. For improving | No addition | Sucrose | 0 | Sucrose | Sucrose fatty |
| cooking | | fatty acid | | fatty acid | acid ester |
| adaptability | | ester | | ester (0.05) | (0.05) |
| (mass %) | | (0.001) | | | |
| Linolenic acid | 6 | 6 | 6 | 6 | 0.1 |
| content | | | | | |
| (mass %) | | | | | |
| Tocopherol | 0.1 | 0.1 | 0.1 | 0.1 | 0.07 |
| content | | | | | |
| (mass %) | | | | | |
| Oryzanol | 0 | 0 | 0 | 0 | 0 |
| content | | | | | |
| (mass %) | | | | | |

| | | | | Example 9 |
|---|---|---|---|---|
| | Example 6 | | Example 8 | Rapeseed oil + |
| | Olive oil + Plant | Example 7 | Rapeseed oil + | Mixed rice oil + |
| | sterol | Rice oil | Plant sterol | Plant sterol |
| Plant sterol | 2.1 | 2.1 | 2.1 | 2.1 |
| content | | | | |
| Lipophilic | | | | |
| emulsifying | | | | |
| agent | | | | |
| 1. For | Polyglycerin | Polyglycerin | Polyglycerin | Polyglycerin |
| suppressing | condensed | condensed | condensed | condensed |
| deposition | ricinoleate | ricinoleate | ricinoleate | ricinoleate |
| (mass %) | ester (0.05) | ester (0.05) | ester (0.05) | ester (0.05) |
| 2. For improving | Sucrose fatty | Polyglycerin | Sucrose fatty | Sucrose fatty |
| cooking | acid ester | fatty acid | acid ester | acid ester |
| adaptability | (0.05) | ester (0.05) | (0.05) | (0.05) |
| (mass %) | | | | |
| Linolenic acid | 1.2 | 0.3 | 20 | 7 |
| content | | | | |
| (mass %) | | | | |
| Tocopherol | 0.008 | 0.05 | 0.06 | 0.05 |
| content | | | | |
| (mass %) | | | | |
| Oryzanol | 0 | 0.37 | 0 | 0.26 |
| content | | | | |
| (mass %) | | | | |

| Effect | Ex. 1 | Ex. 2 | Ex. 3 | Ex. 4 | Ex. 5 | Ex. 6 | Ex. 7 | Ex. 8 | Ex. 9 |
|---|---|---|---|---|---|---|---|---|---|
| Transparency | ◯ | X | ◯ | ◯ | ◯ | ◯ | ◯ | ◯ | ◯ |
| Cooking | ◯ | ◯ | X | ◯ | ◯ | ◯ | ◯ | ◯ | ◯ |
| adaptability | | | | | | | | | |
| Flavor | ◯ | ◯ | ◯ | ◯ | ◯ | ◯ | ◯ | ◯ | ◯ |
| Effect of inhibiting | X | ◯ | ◯ | ◯ | Δ | Δ | Δ | ◯ | ⊚ |
| cholesterol absorption | | | | | | | | | |

The soy bean oil and the rapeseed oil manufactured by THE NISSHIN OIL MILLS, LTD. were used as the samples shown in the table given above, and the unpolished rice oil available on the market was used as the rice oil shown in the table given above.

The details of the properties shown in the table given above are as follows:

Added plant sterol: The plant sterol manufactured by ADM Inc. was added so as to control the plant sterol content as shown in the table.

Transparency: The prepared edible fat/oil composition was put in a container, and the container was hermetically closed and stored in a refrigerating room for one month at 5° C. After the storage, the edible fat/oil composition was visually observed. The mark “◯” shown in the table denotes that the composition was transparent, and the mark “x” denotes that the composition was opaque or a precipitate was found.

Cooking adaptability: A pork cutlet was fried, and the foaming was visually observed. The mark “◯” shown in the table denotes that the foaming degree was substantially equal to that of the soy bean oil, and the mark “x” denotes that the edible fat/oil composition was foamed more vigorously.

Flavor: The edible fat/oil composition was heated to 180° C., and the flavor was functionally evaluated.

Effect of inhibiting cholesterol absorption: The changes with time in the amount of cholesterol contained in remnant-like lipoprotein in the blood were measured. The mark “◯” shown in the table denotes that the average value of the index denoted by the ratio in the case of the reference food and the tested food (i.e., the inhibiting rate of the cholesterol absorption denoted by a relative value) was 20% or more, the mark “Δ” denotes that the average value noted above was 5% or more and smaller than 20%, and the mark “x” denotes that the average value noted above was smaller than 5%.

HLB values of emulsifying agents used:

Polyglycerin condensed ricinoleate ester: 3;

Sucrose fatty acid ester: 3;

Polyglycerin fatty acid ester: 4.

As described above in detail, the present invention provides an edible fat/oil composition containing a plant sterol, which permits suppressing the deposition of the plant sterol during, for example, the storage of the composition and which produces the effect of, for example, inhibiting the absorption of cholesterol.

1-27. (canceled)

28. A method of preparing an edible fat/oil composition comprising an edible fat/oil, and containing a plant sterol in an amount of 1 to 10 mass %, and a lipophilic emulsifying agent in an amount of 0.005 to 10 mass %, the method comprising subjecting a mixture of the edible fat/oil and the plant sterol to deodorizing treatment and adding the lipophilic emulsifying agent to the deodorized mixture.

29. The method according to claim 28, further comprising adding tocopherol to the mixture in an amount such that the composition contains tocopherol in an amount of 0.01 to 1 mass %.

30. The method according to claim 28, wherein the plant cholesterol comprises a fatty acid ester thereof.

31. The method according to claim 28, wherein the edible fat/oil comprises rice oil in an amount of 10 mass % or more.

32. The method according to claim 28, wherein the lipophilic emulsifying agent comprises at least one selected from the group consisting of sucrose fatty acid ester, glycerin fatty acid ester, sorbitan fatty acid ester, and propylene glycol fatty acid ester.
